(19) United States
(12) Patent Application Publication
(10) Pub. No.: US 2009/0029209 A1
(43) Pub. Date: Jan. 29, 2009

(54) FUEL CELL APPARATUS

(75) Inventors: Cheng WANG, Hsinchu (TW); Jin-Shu Huang, Hsinchu (TW); Ching-Po Lee, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/043,970

(22) Filed: Mar. 7, 2008

(30) Foreign Application Priority Data
Jul. 26, 2007 (TW) 96127216

(51) Int. Cl. H01M 8/04

(52) U.S. Cl. 429/22

(57) ABSTRACT

A fuel cell apparatus includes a fuel cell module, a pump, a mixing tank, a circulating piping, a valve, a cartridge, and a pressing element. The circulating piping having a first opening is connected to the fuel cell module, pump, and mixing tank. The valve is disposed at the first opening for optionally covering it. The mixing tank stores first fuel. The cartridge connected to a sidewall of the first opening stores second fuel. The concentration of the second fuel is higher than that of the first fuel. The pressing element presses the cartridge to deform it. When the pump is turned on, the valve is closed to cover the first opening, and the first fuel is transported to the fuel cell module. When the pump is turned off, the valve is opened to expose the first opening, and the second fuel is transported to the mixing tank.

### CROSS-REFERENCE TO RELATED APPLICATION

This application claims the priority benefit of Taiwan application serial no. 96127216, filed on Jul. 26, 2007. The entirety the above-mentioned patent application is hereby incorporated by reference herein and made a part of specification.

### BACKGROUND OF THE INVENTION

1. Field of the Invention

The present invention generally relates to a cell and, in particular, to a fuel cell.

2. Description of Related Art

Fuel cell technology is a highly-efficient power generation technology which offers low noise and no air pollution. Fuel cells may be categorized into various types, such as, in general, proton exchange membrane fuel cells (PEMFC) and direct methanol fuel cells (DMFC). The fuel cell module in a DMFC includes a proton exchange membrane and a cathode and an anode respectively disposed at both sides of the proton exchange membrane.

A DMFC uses methanol aqueous solution as its fuel, and the reaction formulae thereof are:

Anode: CH₃OH+H₂O→CO₂+6H⁺+6e⁻

Cathode: 3/2O₂+6H⁺+6e⁻→3H₂O

Overall reaction: CH₃OH+3/2O₂→CO₂+2H₂O

FIG. 1 is a schematic diagram of a conventional fuel cell apparatus. Referring to FIG. 1, a conventional fuel cell apparatus 100 includes a fuel cell module 110, a mixing tank 120, a pump 130, a circulating piping 140, a valve 150, a cartridge 160, a pump 170, and a fuel transportation piping 180. The circulating piping 140 is connected to the fuel cell module 110, the mixing tank 120, and the pump 130. The valve 150 is disposed in the circulating piping 140. The fuel transportation piping 180 is connected to the cartridge 160, the pump 170, and the valve 150. The pump 170 is disposed between the cartridge 160 and the valve 150.

According to the conventional technique, when the concentration of methanol aqueous solution transported into the fuel cell module 110 is within a standard range, the pump 130 is turned on, and the pump 170 and the valve 150 are turned off. Here the methanol aqueous solution in the mixing tank 120 is transported into the fuel cell module 110 continuously, and the water produced by the reaction of the fuel cell module 110 and the remaining methanol aqueous solution are recycled into the mixing tank 120. When the concentration of methanol aqueous solution transported into the fuel cell module 110 is lower than the standard range, the pump 130 is turned off, and the pump 170 and the valve 150 are turned on. Here methanol of higher concentration in the cartridge 160 is transported into the mixing tank 120 to increase the concentration of the methanol aqueous solution in the mixing tank 120 to the standard range. After that, the pump 170 and the valve 150 are turned off and the pump 130 is turned on, so as to continuously transport methanol aqueous solution into the fuel cell module 110.

In the conventional technique described above, the pump 130 and the pump 170 are turned on alternately and electric power is consumed when they are turned on, so that the power output of the fuel cell apparatus 100 is reduced. In addition, because two pumps 130 and 170 are used in the conventional technique, the fabrication cost of the conventional fuel cell apparatus 100 is high. Moreover, the pumps 130 and 170 are moving parts and accordingly have high failure rate, so that the reliability of the fuel cell apparatus 100 is reduced.

### SUMMARY OF THE INVENTION

Accordingly, the present invention is directed to a fuel cell apparatus having low fabrication cost and high power output.

An embodiment of the present invention provides a fuel cell apparatus including a fuel cell module, a pump, a mixing tank, a circulating piping, a valve, a cartridge, and a pressing element. The circulating piping has a first opening and is connected to the fuel cell module, the pump, and the mixing tank. The valve is disposed at the first opening for optionally covering the first opening. The mixing tank is used for storing first fuel. The cartridge is connected to a sidewall of the first opening and is used for storing second fuel. The concentration of the second fuel is higher than the concentration of the first fuel. The pressing element is used for pressing the cartridge so as to deform the cartridge. When the pump is turned on, the valve is closed to cover the first opening, and the first fuel is transported into the fuel cell module. When the pump is turned off, the valve is opened to expose the first opening, and the second fuel in the cartridge deformed by the pressing element is transported into the mixing tank.

Since the number of pumps required in the fuel cell apparatus according to the present embodiment is by one less than that of pumps required in the conventional technique, the fabrication cost of the fuel cell apparatus is reduced and the power output and reliability thereof are improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional fuel cell apparatus.

FIG. 2A and FIG. 2B are schematic diagrams of a fuel cell apparatus according to an embodiment of the present invention.

FIG. 3A and FIG. 3B are schematic diagrams of a switch button, a pressing element, and a cartridge in a fuel cell apparatus according to an embodiment of the present invention.

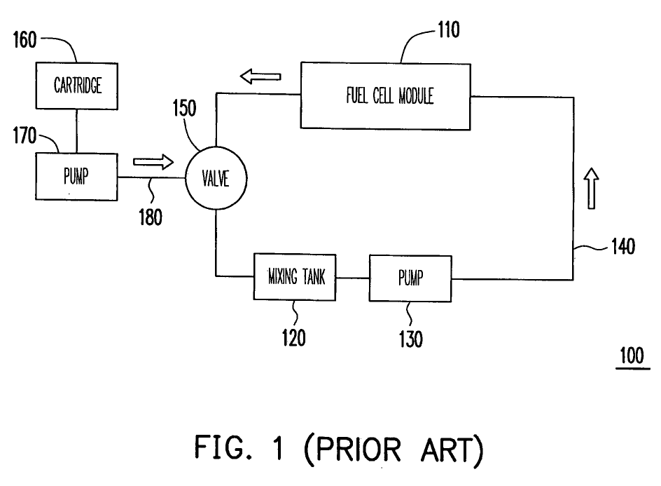

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

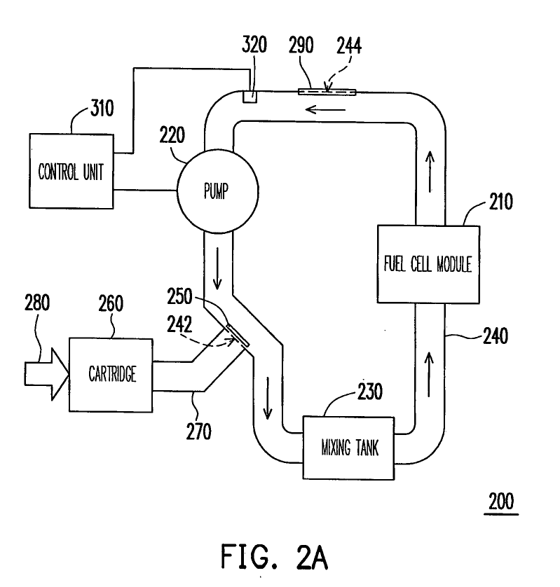

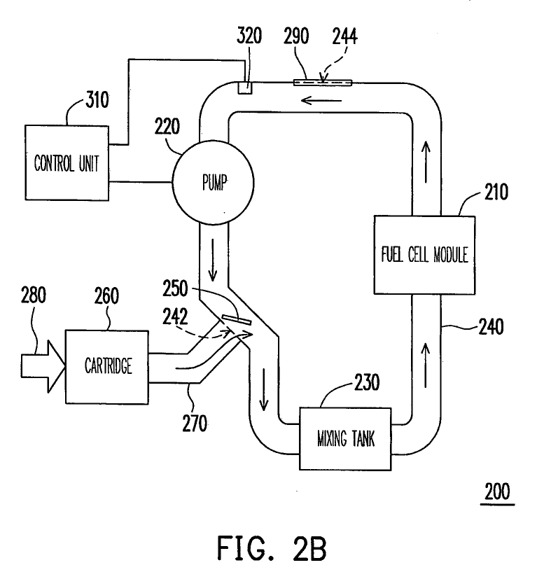

FIG. 2A and FIG. 2B are schematic diagrams of a fuel cell apparatus according to an embodiment of the present invention. Referring to both FIG. 2A and FIG. 2B, in the present embodiment, a fuel cell apparatus 200 includes a fuel cell module 210, a pump 220, a mixing tank 230, a circulating piping 240, a valve 250, a cartridge 260, and a pressing element 280. The circulating piping 240 is connected to the fuel cell module 210, the pump 220, and the mixing tank 230, and the circulating piping 240 has a first opening 242. The valve 250 is disposed at the first opening 242 for optionally covering the first opening 242. The mixing tank 230 is used for storing first fuel. The cartridge 260 is connected to the sidewall of the first opening 242 and is used for storing second fuel, and the concentration of the second fuel is higher than the concentration of the first fuel. For example, the second fuel may be pure methanol, and the first fuel may be a methanol aqueous solution after being diluted. In the present embodiment, the fuel cell apparatus 200 may further include a fuel transportation piping 270. The cartridge 260 is connected to the sidewall of the first opening 242 through the fuel transportation piping 270. The pressing element 280 is used for pressing the cartridge 260 so as to deform the cartridge 260. When the pump 220 is turned on, the valve 250 is closed to cover the first opening 242 (as shown in FIG. 2A), and the first fuel is transported into the fuel cell module 210. When the pump 220 is turned off, the valve 250 is opened to expose the first opening 242 (as shown in FIG. 2B), and the second fuel in the cartridge 260 deformed by the pressing element 280 is transported into the mixing tank 230.

The valve 250 in the fuel cell apparatus 200 may be a passive valve. The passive valve may be a check value, such as a reed valve. The pressing element 280 may be a pressed spring, rubber, or spring leaf. The circulating piping 240 may further have a second opening 244. The fuel cell apparatus 200 may further include a gas-permeable liquid-proof membrane 290 covering the second opening 244. The gas-permeable liquid-proof membrane 290 is in communication with external gas, so that the pressure P0 supplied to the gas-permeable liquid-proof membrane 290 by the first fuel is a constant when the pump 220 is turned off. In addition, the pressure supplied to the cartridge 260 by the pressing element 280 is PI. When the pump 220 is turned on, the pressure supplied to the valve 250 by the fluid in the circulating piping 240 is P2. When the pump 220 is turned off, the pressure supplied to the valve 250 by the fluid in the circulating piping 240 is P3, and P0=P3<P1<P2. Moreover, since the pressure supplied to the cartridge 260 by the pressing element 280 is P1, the pressure supplied to the valve 250 by the second fuel in the cartridge 260 is about equal to P1.

As described above, when the pump 220 is turned on, because the pressure P2 is higher than the pressure P1, the valve 250 is turned off and the second fuel is not transported into the mixing tank 230. Besides, the first fuel in the mixing tank 230 is supplied to the fuel cell module 210 to react in the fuel cell module 210. The liquid (for example, water) produced by the reaction in the fuel cell module 210 and the remaining first fuel is recycled into the mixing tank 230.

On the other hand, when the pump 220 is turned off, since the pressure P3 is lower than the pressure P1, the valve 250 is turned on and the second fuel in the cartridge 260 is supplied into the mixing tank 230 and mixes with the liquid in the mixing tank 230 into suitable concentration of the first fuel.

In the present embodiment, the fuel cell apparatus 200 may further include a control unit 310 for controlling the pump 220 to turn on or off. In addition, the fuel cell apparatus 200 may further include a detector 320 electrically connected to the control unit 310. The control unit 310 controls the pump 220 to turn on or off on the basis of a detection result of the detector 320.

For example, the detector 320 may be a concentration detector disposed inside the circulating piping 240. When the concentration of the first fuel detected by the detector 320 is lower than a minimum threshold, the control unit 310 turns off the pump 220, so that the second fuel in the cartridge 260 is supplied to the mixing tank 230. When the concentration of the first fuel detected by the detector 320 is higher than a maximum threshold, the control unit 310 turns on the pump 220, so that the second fuel in the cartridge 260 is not supplied to the mixing tank 230. Additionally, it should be understood by those having ordinary knowledge in the art that besides being a concentration detector, the detector 320 may also be a temperature detector, a power detector, a voltage detector, or a current detector.

Compared with the conventional technique, the fuel cell apparatus 200 in the present embodiment uses only one pump 220, so that the fabrication cost thereof is reduced. In addition, since the number of operating parts (for example the pump) required in the fuel cell apparatus 200 in the present embodiment is by one less than that of operating parts required in the conventional technique, the reliability thereof is increased. Moreover, since the pump 220 is not constantly turned on, the fuel cell apparatus 200 in the present embodiment consumes less electric power and accordingly the power output thereof is increased.

It should be noted that in the embodiments described above, the valve 250 is a passive valve. However, in another embodiment of the present invention, the valve 250 may also be an active valve, such as a solenoid valve.

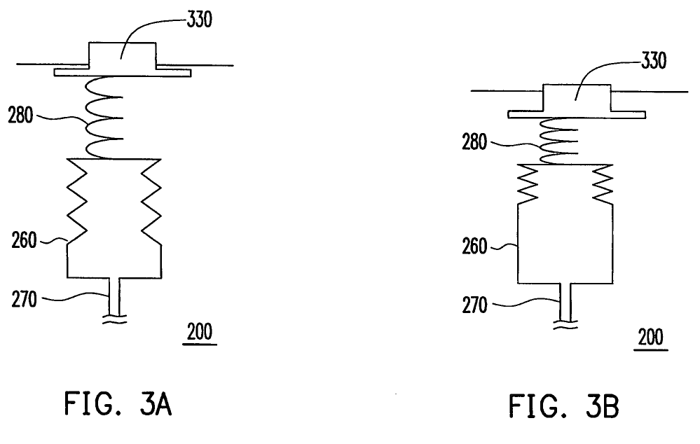

FIG. 3A and FIG. 3B are schematic diagrams of a switch button, a pressing element, and a cartridge in a fuel cell apparatus according to an embodiment of the present invention. Referring to both FIG. 3A and FIG. 3B, the fuel cell apparatus 200 may further include a switch button 330 connected to the pressing element 280. When a user wants to use the fuel cell apparatus 200, the user turns on the switch button 330 (as shown in FIG. 3B) so that the switch button 330 supplies a pressure on the pressing element 280. Accordingly, the pressing element 280 presses the cartridge 260 so that the second fuel in the cartridge 260 enters into the fuel transportation piping 270. On the other hand, when the user wants to stop using the fuel cell apparatus 200, the user turns off the switch button 330 (as shown in FIG. 3A) so that the switch button 330 does not supply the pressure on the pressing element 280. Accordingly, the pressing element 280 does not press the cartridge 260, so that the cartridge 260 is not deformed due to a external force, and the second fuel in the cartridge 260 does not enter into the fuel transportation piping 270 anymore.

In overview, the fuel cell apparatus has at least one of following advantages:

1. Compared with the conventional technique, the number of the pumps required in the fuel cell apparatus according to an embodiment of the present invention is by one less than that of pumps required in the conventional technique, so that the fabrication cost thereof is reduced and the reliability thereof is improved.

2. Because the pump is not continuously turned on, less electric power is consumed, and accordingly the power output of the fuel cell apparatus is increased.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell apparatus, comprising:
a fuel cell module;
a pump;
a mixing tank, for storing first fuel;
a circulating piping, connected to the fuel cell module, the pump, and the mixing tank, the circulating piping having a first opening;
a valve, disposed at the first opening for optionally covering the first opening;
a cartridge, connected to a sidewall of the first opening and used for storing second fuel, wherein a concentration of the second fuel is higher than a concentration of the first fuel; and
a pressing element, for pressing the cartridge to deform the cartridge,
wherein, when the pump is turned on, the valve is closed to cover the first opening and the first fuel is transported into the fuel cell module, and wherein, when the pump is turned off, the valve is opened to expose the first opening and the second fuel in the cartridge deformed by the pressing element is transported into the mixing tank.

2. The fuel cell apparatus according to claim 1 further comprising a gas-permeable liquid-proof membrane, wherein the circulating piping further has a second opening, and the gas-permeable liquid-proof membrane covers the second opening.

3. The fuel cell apparatus according to claim 1, wherein the pressing element supplies a pressure PI to the cartridge, fluid in the circulating piping supplies a pressure P2 to the valve when the pump is turned on, the fluid in the circulating piping supplies a pressure P3 to the valve when the pump is turned off, and P3<P1<P2.

4. The fuel cell apparatus according to claim 1 further comprising a switch button connected to the pressing element, wherein the pressing element presses the cartridge when the switch button is turned on, and the pressing element does not press the cartridge when the switch button is turned off.

5. The fuel cell apparatus according to claim 1, wherein the valve is an active valve or a passive valve.

6. The fuel cell apparatus according to claim 1, wherein the pressing element is a spring, a rubber, or a spring leaf.

7. The fuel cell apparatus according to claim 1 further comprising a control unit electrically connected to the pump for controlling the pump to be turned on or off.

8. The fuel cell apparatus according to claim 7 further comprising a detector electrically connected to the control unit, wherein the control unit controls the pump to be turned on or off on the basis of a detection result of the detector.

9. The fuel cell apparatus according to claim 8, wherein the detector is a concentration detector, a temperature detector, a power detector, a voltage detector, or a current detector.

10. The fuel cell apparatus according to claim 1 further comprising a fuel transportation piping, wherein the cartridge is connected to the sidewall of the first opening through the fuel transportation piping.
